(19) United States
(12) Patent Application Publication
(10) Pub. No.: US 2018/0335982 A1
(43) Pub. Date: Nov. 22, 2018

(54) PRINTING APPARATUS AND PRINT JOB DISPLAYING METHOD

(71) Applicant: SEIKO EPSON CORPORATION, Tokyo (JP)

(72) Inventors: Satoshi KOTAKA, Azumino (JP); Yuki YAMADA, Shiojiri (JP)

(21) Appl. No.: 15/973,187

(22) Filed: May 7, 2018

(30) Foreign Application Priority Data
May 16, 2017 (JP) 2017-097042

(51) Int. Cl. G06F 3/12

(52) U.S. Cl. CPC G06F 3/1207; G06F 3/1286; G06F 3/1262; G06F 3/1259

(57) ABSTRACT

A printing apparatus includes a receiving section configured to receive print jobs, and a display control section configured to cause a display section to display a list of the print jobs received by the receiving section. If date and time the receiving section received a reservation print job that is a print job waiting for a print instruction is earlier than date and time the receiving section receives a print job to which a print instruction has been issued and to be output to a print section, the display control section causes the display section to display the print job to be output at a position in the list higher than the position of the reservation print job waiting for a print instruction.

### BACKGROUND

### 1. Technical Field

The present invention relates a printing apparatus and a print job displaying method.

### 2. Related Art

A list of jobs that have been submitted from external devices to a printer are displayed on a display panel of the printer. On the panel, the jobs that have been submitted earlier to the printer are displayed on the top side (upper side) of the list.

JP-A-2011-235613 discloses such an apparatus that includes a job management unit for managing the order of processing of stored jobs, a job processing unit for sequentially processing the jobs according to the processing order, and a receiving unit for receiving a request for changing the processing order to change the processing order of a first job that is being received to the order before a predetermined second job among the stored jobs, in which the job management unit changes the processing order after the completion of the reception of the first job.

Example jobs submitted to a printer include a print job that is temporarily stored in a predetermined storage unit and when a print instruction is issued later, the stored job is printed. In the known printers that display submitted jobs such that the jobs submitted earlier to the printer are displayed on the top side of the list, the order of the jobs being displayed may not match the actual job processing order. Accordingly, it is difficult for users to know the actual processing order of the jobs from the information on the panel.

### SUMMARY

An advantage of some aspect of the invention is that there is provided a printing apparatus enabling users to know a job processing order more accurately and a method of displaying print jobs.

According to an aspect of the invention, a printing apparatus includes a receiving section configured to receive print jobs, and a display control section configured to cause a display section to display a list of the print jobs received by the receiving section. If date and time the receiving section received a reservation print job that is a print job waiting for a print instruction is earlier than date and time the receiving section receives a print job to which a print instruction has been issued and to be output to a print section, the display control section causes the display section to display the print job to be output at a position in the list higher than the position of the reservation print job waiting for a print instruction.

With this configuration, a print job that is to be output to the print section is displayed at a position in the list higher than the position of the reservation print job waiting for a print instruction. Consequently, the print jobs are displayed on the display section in a manner highly consistent with actual print job processing order. If date and time the receiving section received a reservation print job waiting for a print instruction is later than date and time the receiving section received a print job to which a print instruction has been issued and to be output to a print section, the display control section causes the display section to display the print job to be output at a position in the list higher than the position of the reservation print job waiting for a print instruction according to the order of reception date and time.

The display control section may cause the display section to display a print job on which a preparation process is to be performed and the output to the print section has not yet been started at a position in the list higher than the position of the print job waiting for a print instruction among the reservation print jobs. With this configuration, a print job on which a preparation process is to be performed and the output to the print section has not yet been started is displayed at a position in the list higher than the position of the print job waiting for a print instruction. Consequently, the print jobs are displayed on the display section in a manner highly consistent with actual print job processing order. The preparation process may include at least one of a storing process for storing a print job in a predetermined buffer and a storing process for storing a print job in a print queue.

The display control section may cause the display section to display the print job to be output at a position in the list higher than the position of the print job on which the preparation process is to be performed. With this configuration, the print job that is to be output to the print section is displayed at a position in the list higher than the position of the print job on which the preparation process is to be performed. Consequently, the print jobs are displayed on the display section in a manner highly consistent with actual print job processing order.

The display control section causes the display section to display the list including a print job, a facsimile transmission job to be processed in facsimile transmission, and a network transmission job to be transmitted to the outside via a network. With this configuration, users can check statuses of the jobs including the print job, the facsimile transmission job, and the network transmission job in one list.

The display control section may cause the display section to display the facsimile transmission job and the network transmission job at positions in the list lower than the position of the print job to be output. With this configuration, the facsimile transmission job and the network transmission job are always displayed at positions in the list lower than the position of the print job to be output. Accordingly, the facsimile transmission job and the network transmission job are not mixed with the print job to be output to the print section in the list and the user can readily check the print job being printed.

The printing apparatus may further include a display specification receiving section configured to receive a selection of a first display specification for displaying the print job in a list and displaying the facsimile transmission job and the network transmission job in another list, or a second display specification for displaying the list including the print job, the facsimile transmission job, and the network transmission job. The display control section causes the display section to display the list including the print job, the facsimile transmission job, and the network transmission job when the second display specification is selected. With this configuration, users can select one of the first display specification and the second display specification.

The technical thoughts of the invention may be implemented in various ways other than the category of printing apparatuses. For example, a print job displaying method includes receiving print jobs, and causing a display section to display a list of the received print jobs. If date and time of the reception of a reservation print job that is a print job waiting for a print instruction received in the receiving is earlier than date and time of the reception of a print job to which a print instruction has been issued and to be output to a print section received in the receiving, in the causing the display section to display the list of the received print jobs, displaying the print job to be output at a position in the list higher than the position of the reservation print job waiting for a print instruction. Furthermore, the invention includes a program that causes hardware (computer) to implement the method and a computer-readable storage medium that stores the program.

### BRIEF DESCRIPTION OF THE DRAWINGS

The invention will be described with reference to the accompanying drawings, wherein like numbers reference like elements.

FIG. 1 illustrates a part of the functions of a printer.

FIG. 2 is a table showing correspondence relations between processing statuses of print jobs and display categories.

FIG. 3 is a flowchart showing a display control process of a job list.

FIG. 4 illustrates an example job list.

FIG. 5 illustrates another example job list.

### DESCRIPTION OF EXEMPLARY EMBODIMENTS

Hereinafter, embodiments of the invention will be described with reference to the attached drawings. It is to be understood that these drawings are merely illustrative of the embodiments.

### 1. Schematic Description of Functions of Printer

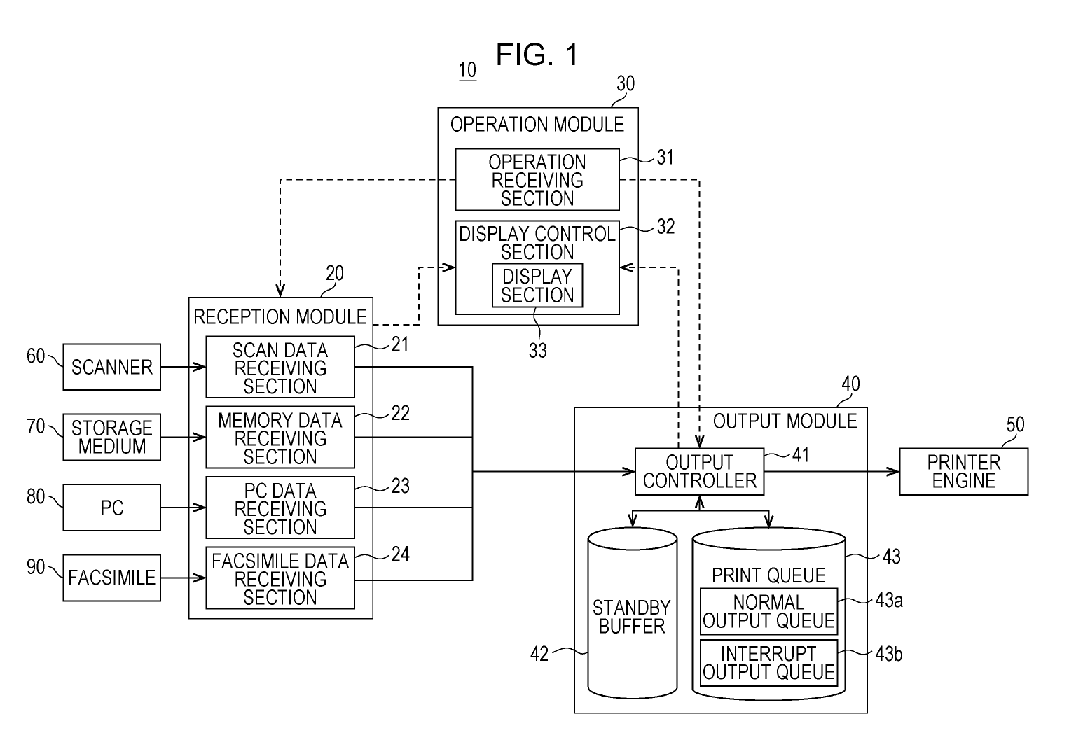

FIG. 1 is a block diagram illustrating a part of the functions of a printer 10, which is a printing apparatus according to the embodiment. The printer 10 is an executing entity of a method of displaying print jobs according to the embodiment. The printer 10 includes a reception module 20, an operation module 30, an output module 40, and a printer engine 50. Each of the modules 20, 30, and 40 is a function implemented by the cooperation between hardware (for example, one or more integrated circuits (ICs) having a central processing unit (CPU), a read-only memory (ROM), a random access memory (RAM), or the like, other storage devices, or the like) in the printer 10 and a program. The printer 10 may be a stationary printer or a portable compact printer (mobile printer).

The reception module 20 functions as an interface for receiving print jobs from outside, and to which print jobs can be submitted from a plurality of input systems as needed. In the example in FIG. 1, the reception module 20 includes a scan data receiving section 21, a memory data receiving section 22, a personal computer (PC) data receiving section 23, and a facsimile data receiving section 24.

The scan data receiving section 21 receives scan data generated by a scanner 60 by optically reading an original document from the scanner 60 as a print job. The memory data receiving section 22 reads memory data (an image file) stored in a storage medium 70 (for example, a Secure Digital (SD) card, a universal serial bus (USB) memory, or other memories) that is connected to a connector in the printer 10. The PC data receiving section 23 receives a print job sent from an external PC 80 that is connected to the printer 10 by a wired line or radio. It should be noted that the PC data receiving section 23 can receive a print job not only from the PC but also from various external communication devices such as a smart phone, a cellular phone, or a digital still camera. The facsimile data receiving section 24 receives a facsimile signal sent from an external facsimile machine 90 as a print job.

The print job is data of an image (an image including characters, a photograph, graphics or the like) to be printed, print conditions, or the like in a predetermined format or a command, and interpreted by a printer engine 50 and printed. It should be noted that it is not necessary for the print job to be expressed in a format that can be interpret by the printer engine 50 from the beginning (at the time the print job is received by the reception module 20).

The scanner 60 may be an external device of the printer 10 or may be a function implemented by the printer 10. The facsimile data receiving section 24 can send a facsimile signal to the outside and may be referred to as a facsimile communication section. If the printer 10 includes such scanner 60 and facsimile communication section, the printer 10 may be referred to as a multifunction peripheral.

The operation module 30 includes an operation receiving section 31 and a display control section 32. The operation receiving section 31 receives operations issued by users via physical buttons, a touch panel, or the like of the printer 10. The display control section 32 is implemented by a display (display section 33) such as a liquid crystal display and a controller for controlling display implemented by the display section 33 to provide various kinds of visual information. In this embodiment, specifically, the display control section 32 causes the display section 33 to display a list (job list) of print jobs that have been submitted to the printer 10. A touch panel that is an example operation receiving section 31 is implemented on the display section 33. Hereinafter, a configuration that includes the reception module 20 and the operation receiving section 31 is referred to as a reception section.

The output module 40 includes an output controller 41, a standby buffer 42, and a print queue 43. The output controller 41 performs various control operations such as storage, format conversion, and output to the printer engine 50 with respect to jobs input from the reception module 20. The format conversion is a process of converting the format of a print job into a format that can be interpret by the printer engine 50 to perform printing as necessary. The standby buffer 42 is a storage section for storing print jobs input from the reception module 20. A print job that is stored in the standby buffer 42 is referred to as a reservation print job.

The print queue 43 is a storage section in which print jobs are placed to be output to the printer engine 50 or a queue of print jobs. All reservation print jobs and print jobs that are not the reservation print jobs are to be input to the print queue 43 before the print jobs are output to the printer engine 50. The print queue 43 includes a normal output queue 43a and an interrupt output queue 43b in which print jobs (interrupt jobs) that have higher print priority than the print jobs in the normal output queue 43a are to be placed.

The printer engine 50 is a print section that receives a print job output from the print queue 43 by the output controller 41, interprets the received print job, and performs printing. The printer engine 50 may employ various methods such as an ink jet method or an electrophotographic method. The output module 40, specifically, the output controller 41, is referred to as a print controller that outputs a print job to a print section and causes the print section to perform printing according to the print job.

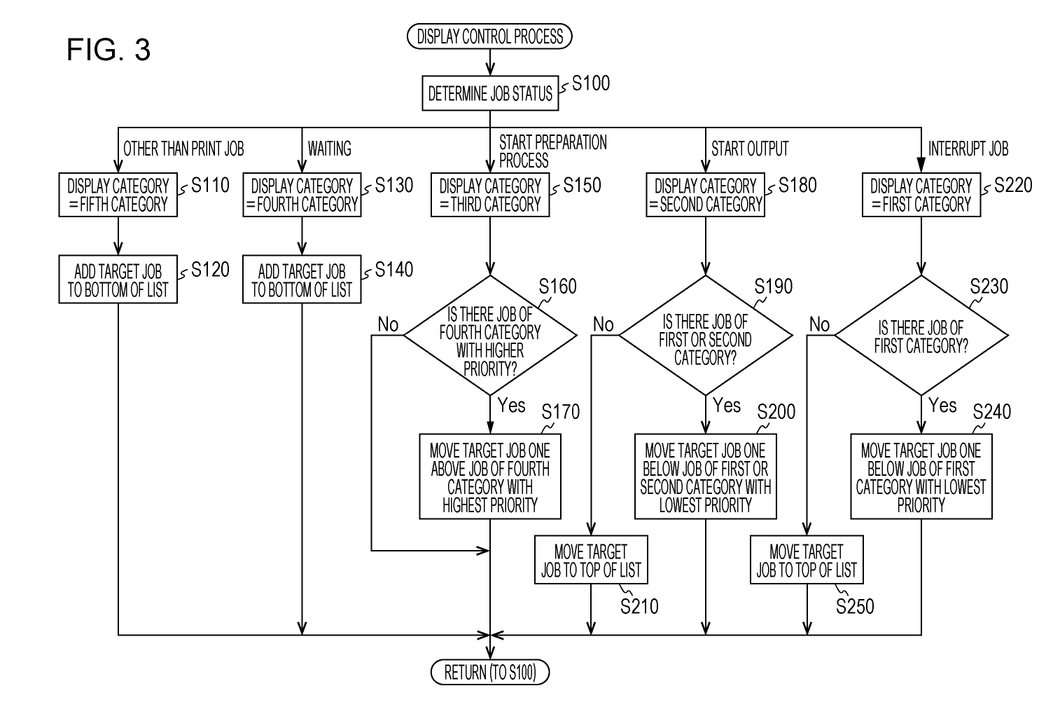

From the operation receiving section 31 to the reception module 20 or the output module 40, various instructions corresponding to user's operations, for example, a print instruction, are sent. The reception module 20 and the output module 40 perform processes in accordance with the transmitted instructions. From the reception module 20 or the output module 40 to the display control section 32, the statuses of the reception of print jobs and processes are sequentially notified, and based on the notifications, the display control section 32 updates the contents (for example, the display order of the print jobs) of the job list displayed on the display section 33 (see FIG. 3 for details).

### 2. Process Flow of Print Job

Next, a flow of processes corresponding to the types of print jobs will be briefly described. In this embodiment, as mentioned above, the print jobs are roughly divided into reservation print jobs and print jobs (hereinafter, referred to as immediate print jobs) that are not reservation jobs. The printer 10 can determine the type of each print job based on identification information included in the print job or an instruction of the type of print job issued by a user through the operation receiving section 31.

The reception module 20 can receive print jobs in the respective corresponding above-mentioned input systems and sequentially transfer the received print jobs to the output module 40. When the output controller 41 in the output module 40 inputs a print job into the print queue 43, basically, adds the print job to the bottom of the normal output queue 43a. If the print job is an interrupt job, the output controller 41 adds the print job to the bottom of the interrupt output queue 43b. The printer 10 can also determine whether the print job is an interrupt job or not, for example, based on the information whether the print job includes specific identification information indicating that the print job is an interrupt job, which can be included in the print job, or an interrupt instruction issued by the user via the operation receiving section 31.

If there are one or more print jobs in the interrupt output queue 43b, the output controller 41 sequentially reads the print jobs from the top of the interrupt output queue 43b, performs format conversion as appropriate, and outputs the print jobs to the printer engine 50. If there is no print job in the interrupt output queue 43b, the output controller 41 sequentially reads the print jobs from the top of the normal output queue 43a, performs format conversion as appropriate, and outputs the print jobs to the printer engine 50. When the output of the respective jobs to the printer engine 50 has completed, the output controller 41 deletes the print jobs in the print queue 43 from the print queue 43. If a “job stop instruction” is issued to a print job in the print queue 43 by a user via the operation receiving section 31 before the completion of the output to the printer engine 50, the output controller 41 also deletes the print job from the print queue 43.

If an immediate print job is input from the reception module 20, the output controller 41 inputs the job to the print queue 43 without storing the job in the standby buffer 42. With this operation, printing based on the immediate print job is executed by the printer engine 50.

If a reservation print job is input from the reception module 20, the output controller 41 processes as described below. The reservation print job is classified into a more detailed category, for example, a reprint job, a sample print job, a storage print job, or an authentication print job. The reprint job refers to a print job for the printer to print all pages of the job once while storing the job in the standby buffer 42. If the reprint job is input from the reception module 20, the output controller 41 stores the reprint job in the standby buffer 42 and inputs the reprint job to the print queue 43. With this operation, printing based on the reprint job is executed once by the printer engine 50.

After the first printing of the reprint job has completed, if a “job restart instruction” is issued to the reprint job by the user via the operation receiving section 31, the output controller 41 reads the reprint job from the standby buffer 42 and inputs the reprint job to the print queue 43. With this operation, the second printing of the reprint job is executed. The “job restart instruction” corresponds to a print instruction to a reservation print job.

The sample print job refers to a print job for the printer to print all pages of the job once, that is, print only one copy, while storing the job in the standby buffer 42 when an instruction for printing a plurality of copies (N copies) has been issued. If the sample job is input from the reception module 20, the output controller 41 stores the sample print job in the standby buffer 42 and inputs the sample print job to the print queue 43. With this operation, printing based on the sample print job is executed once by the printer engine 50, that is, only one copy is printed. After the printing of the one copy of the sample print job has completed, if a “job restart instruction” is issued to the sample print job by the user via the operation receiving section 31, the output controller 41 reads the sample print job from the standby buffer 42 and inputs the sample print job to the print queue 43. In this operation, the output controller 41 causes the printer engine 50 to execute printing of the remaining copies (N−1 copies) of the sample print job.

The storage print job refers to a print job for the printer to store the job in the standby buffer 42 without performing printing. If the storage print job is input from the reception module 20, the output controller 41 stores the storage print job in the standby buffer 42. After the storage operation, if a “job restart instruction” is issued to the storage print job by the user via the operation receiving section 31, the output controller 41 reads the storage print job from the standby buffer 42 and inputs the storage print job to the print queue 43. With this operation, printing based on the storage print job is executed by the printer engine 50.

The output controller 41 does not delete the reprint job, the sample print job, and the storage print job from the standby buffer 42 after the completion of the output of the respective jobs to the printer engine 50. If a “job stop instruction” is issued to the reprint job, the sample print job, or the storage print job by the user via the operation receiving section 31, the output controller 41 deletes the corresponding job from the standby buffer 42.

The authentication print job refers to a print job for the printer to store the job in the standby buffer 42 without performing printing. If the authentication print job is input from the reception module 20, the output controller 41 stores the authentication print job in the standby buffer 42. After the storage operation, if a “job restart instruction” is issued to the authentication print job by the user via the operation receiving section 31, the output controller 41 performs necessary authentication processing, and only when the authentication processing has been successfully processed, reads the authentication print job from the standby buffer 42 and inputs the authentication print job to the print queue 43. The authentication process is performed, for example, to urge a user to enter authentication information (the user ID, password, or the like) via the operation receiving section 31 to determine whether the entered authentication information matches registered valid authentication information. If the entered authentication information matches the valid authentication information, the authentication is successfully processed. With this process, only the valid user (authenticated user) can obtain the print result processed by the printer engine 50 based on the authentication print job.

Unlike the reprint job, the sample print job, and the storage print job, the output controller 41 deletes the authentication print job from the standby buffer 42 after the completion of the job output to the printer engine 50. If a “job stop instruction” is issued to the authentication print job, the output controller 41 also deletes the authentication print job from the standby buffer 42.

### 3. Relationship Between Print Job Status and Display Category

Next, the relationship between statuses of print jobs processed according to the above-described flow and display categories of the print jobs in a job list will be described. In this embodiment, the display categories of print jobs are roughly divided into first to four categories. A first category indicates an “interrupting” print job, a second category indicates an “outputting” print job, a third category indicates a print job “in preparation”, and a fourth category indicates a “waiting” print job. In a job list, a print job in the first category is displayed with the highest priority, and a job in the second category is displayed with the second highest priority with respect to the printing job in the first category. A print job in the third category is displayed with a higher priority than a print job in the fourth category.

The expression “displayed with a higher priority” means that the display position in the job list is higher. Basically, the upper side of the list indicates higher priority in the display order in the job list. Depending on specific designs (ways to show the job list to users) of the job list on the display section 33, however, the upper side of the list does not always mean higher priority in the list. For example, if a job list is designed to arrange and display a plurality of jobs from side to side, one side (for example the left side) of the left and right sides in the job list may be defined as a side with higher priority.

The print job in the first category “interrupting” corresponds to a print job that is defined as an interrupt job. The print job in the second category “outputting” corresponds to a print job other than print jobs in the first category “interrupting” and the output of the print job from the print queue 43 to the printer engine 50 has been started by the output controller 41.

The print job in the third category “in preparation” corresponds to a job that is not in the first category “interrupting” and the second category “outputting” and is a target of a process (preparation process) performed by the output controller 41. The preparation process here includes, for example, a process (process for storing a print job in a buffer) for inputting a print job transferred from the reception module 20 in the standby buffer 42, a process (process for storing a print job in a print queue) for inputting a print job transferred from the reception module 20 in the print queue 43, and a process (process for storing a print job in a print queue) for reading a print job (reservation print job) stored in the standby buffer 42 and inputting the print job in the print queue 43.

The print job in the fourth category “waiting” corresponds to a print job that is not in any of the first category “interrupting”, the second category “outputting” and the third category “in preparation”. The print job in the fourth category “waiting” includes, for example, a print job that has been started to be received by the reception module 20 but has not been started to be input in the output module 40, and a print job that has been stored in the standby buffer 42 and is waiting for the “job restart instruction” (waiting for a print instruction).

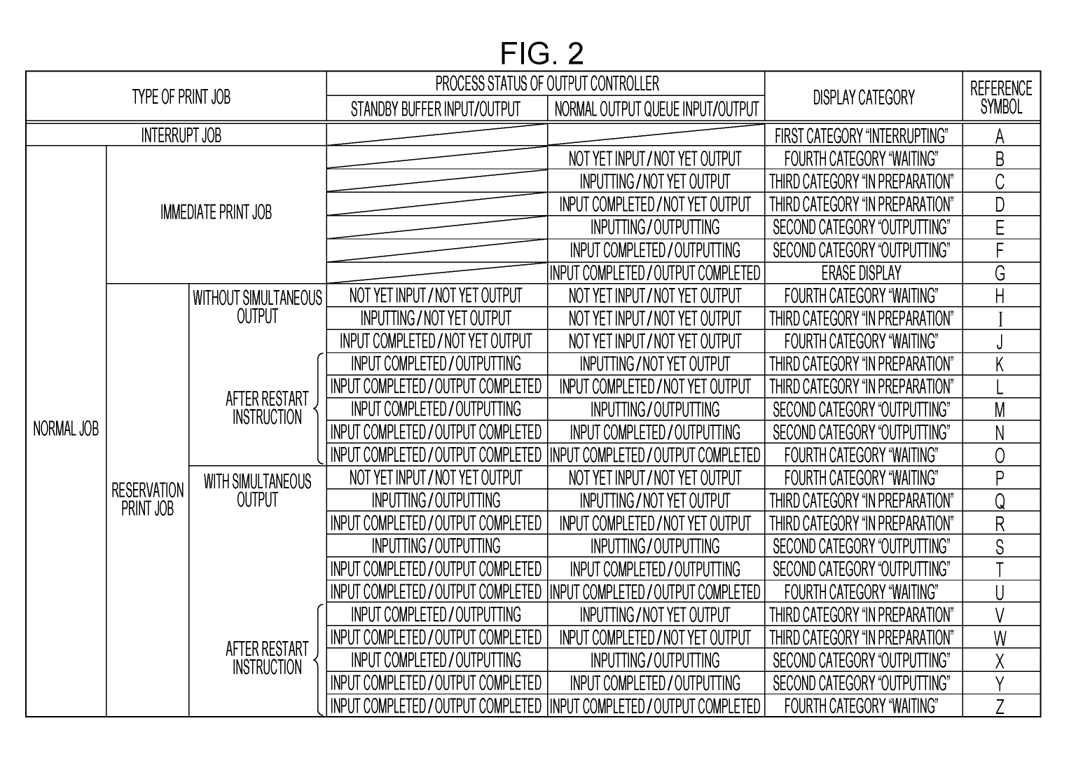

FIG. 2 is a table showing correspondence relationship between statuses of processes of different types of print jobs and display categories in the job list. In FIG. 2, print jobs that do not correspond to the interrupt job are expressed as normal jobs. The normal jobs include immediate print jobs and reservation print jobs, and the reservation print jobs include reservation print jobs “without simultaneous output” and reservation print jobs “with simultaneous output”. The expression “simultaneous output” here means a process for printing a print job while storing the print job in the standby buffer 42. Consequently, the reservation print jobs “without simultaneous output” include the storage print jobs and the authentication print jobs, and the reservation print jobs “with simultaneous output” include the reprint jobs and the sample print jobs. It should be noted that the reference symbols A, B, C . . . shown at the right end of FIG. 2 are merely reference symbols added for the sake of convenience in describing FIG. 2.

As indicated by the symbol A, if a print job corresponds to the interrupt job, regardless of the status of the process of the print job by the output controller 41, the display category of the print job is the first category “interrupting”. Although the interrupt job may be classified into the immediate print job or the reservation print job, the display category of the interrupt job is classified into the first category “interrupting” only by the condition that the job is the interrupt job.

The symbols B to Z indicate that the print jobs are the normal jobs. The symbols B to G indicate that the print jobs are the immediate print jobs. The symbol B indicates a status in which the print job has not yet been input in the normal output queue 43a of the print queue 43 and has not yet been output from the normal output queue 43a. In this case, the reception module 20 has started to receive the print job but has not yet started to input the print job in the output module 40 (the output controller 41), and the display category of the print job is the fourth category “waiting”. The symbol C indicates a status in which the print job is being input in the normal output queue 43a and has not yet been output from the normal output queue 43a. In this case, the print job is in the preparation process, and the display category of the print job is the third category “in preparation”.

The symbol D indicates a status in which the print job has already been input in the normal output queue 43a and has not yet been output from the normal output queue 43a. In this case, the print job is waiting for the completion of output of the other print jobs input prior to the print job in the print queue 43 (the interrupt output queue 43b or the normal output queue 43a), and the display category of the print job is the third category “in preparation”. The symbol E indicates a status in which the print job is being input in the normal output queue 43a and is being output from the normal output queue 43a. In this case, the display category of the print job is the second category “outputting”.

The symbol F indicates a status in which the print job has already been input in the normal output queue 43a and is being output from the normal output queue 43a. In this case, the display category of the print job is the second category “outputting”. The symbol G indicates a status in which the print job has already been input in the normal output queue 43a and has already been output from the normal output queue 43a. In this case, printing of the print job has completed, and the display relating to the print job is erased from the job list.

The symbols H to O indicate that the print jobs are the reservation print jobs “without simultaneous output”. The symbol H indicates a status in which the print job has not yet been input in the standby buffer 42, has not yet been output from the standby buffer 42, has not yet been input in the normal output queue 43a, and has not yet been output from the normal output queue 43a. In this case, the reception module 20 has started to receive the print job but the input of the print job to the output module 40 (the output controller 41) has not yet been started, and the display category of the print job is the fourth category “waiting”. The symbol I indicates a status in which the print job is being input in the standby buffer 42, has not yet been output from the standby buffer 42, has not yet been input in the normal output queue 43a, and has not yet been output from the normal output queue 43a. In this case, the print job is in the preparation process, and the display category of the print job is the third category “in preparation”.

The symbol J indicates a status in which the print job has already been input in the standby buffer 42, has not yet been output from the standby buffer 42, has not yet been input in the normal output queue 43a, and has not yet been output from the normal output queue 43a. In this case, the reservation print job stored in the standby buffer 42 is waiting for the “job restart instruction”, and the display category of the print job is the fourth category “waiting”.

The symbols K to O indicate the reservation print jobs “without simultaneous output”, and the “job restart instructions” to the print jobs have been input via the operation receiving section 31. The symbol K indicates a status in which the print job has already been input in the standby buffer 42, is being output from the standby buffer 42 to the normal output queue 43a (the normal output queue 43a is inputting the print job), and has not yet been output from the normal output queue 43a. In this case, the print job is in the preparation process, and the display category of the print job is the third category “in preparation”.

The symbol L indicates a status in which the print job has already been input in the standby buffer 42, has already been output from the standby buffer 42 to the normal output queue 43a, has already been input in the normal output queue 43a, and has not yet been output from the normal output queue 43a. In this case, the print job is waiting for the completion of output of the other print jobs that have been input prior to the print job in the print queue 43 (the interrupt output queue 43b or the normal output queue 43a), and the display category of the print job is the third category “in preparation”. The symbol M indicates a status in which the print job has already been input in the standby buffer 42, is being output from the standby buffer 42 to the normal output queue 43a (the normal output queue 43a is inputting the print job), and is being output from the normal output queue 43a. In this case, the display category of the print job is the second category “outputting”. The symbol N indicates a status in which the print job has already been input in the standby buffer 42, has already been output from the standby buffer 42 to the normal output queue 43a, has already been input to the normal output queue 43a, and is being output from the normal output queue 43a. In this case, the display category of the print job is the second category “outputting”.

The symbol O indicates a status in which the print job has already been input in the standby buffer 42, has already been output from the standby buffer 42 to the normal output queue 43a, has already been input to the normal output queue 43a, and has already been output from the normal output queue 43a. In this case, although printing of the print job has completed, the print job (if the print job is the storage print job) remains stored in the standby buffer 42, and thus the print job is waiting for the “job restart instruction”, and the display category of the print job is the fourth category “waiting”. In the status indicated by the symbol O, if the print job is the authentication print job, it is considered that printing of the print job has completed, and the print job is deleted from the standby buffer 42 and the display relating to the print job is erased from the job list. When the print job is the storage print job, if the print job is deleted from the standby buffer 42 by the “job stop instruction”, the display relating to the print job is erased from the job list.

The symbols P to Z indicate that the print jobs are the reservation print jobs “with simultaneous output”. Among the symbols, the symbols P to U indicate statuses relating to the “simultaneous output”. The symbol P indicates a status in which the print job has not yet been input in the standby buffer 42, has not yet been output from the standby buffer 42, has not yet been input in the normal output queue 43a, and has not yet been output from the normal output queue 43a. In this case, the reception module 20 has started to receive the print job but the input of the print job to the output module 40 (the output controller 41) has not yet been started, and the display category of the print job is the fourth category “waiting”. The symbol Q indicates a status in which the print job is being input in the standby buffer 42, is being output from the standby buffer 42 (the normal output queue 43a is inputting the print job), and has not yet been output from the normal output queue 43a. In this case, the print job is in the preparation process, and the display category of the print job is the third category “in preparation”.

The symbol R indicates a status in which the print job has already been input in the standby buffer 42, has already been output from the standby buffer 42 to the normal output queue 43a, has already been input in the normal output queue 43a, and has not yet been output from the normal output queue 43a. In this case, the print job is waiting for the completion of output of the other print jobs that have been placed above the print job in the print queue 43 (the interrupt output queue 43b or the normal output queue 43a), and the display category of the print job is the third category “in preparation”. The symbol S indicates a status in which the print job is being input in the standby buffer 42, is being output from the standby buffer 42 to the normal output queue 43a (the normal output queue 43a is inputting the print job), and is being output from the normal output queue 43a. In this case, the display category of the print job is the second category “outputting”. The symbol T indicates a status in which the print job has already been input in the standby buffer 42, has already been output from the standby buffer 42 to the normal output queue 43a, has already been input to the normal output queue 43a, and being output from the normal output queue 43a. In this case, the display category of the print job is the second category “outputting”.

The symbol U indicates a status in which the print job has already been input in the standby buffer 42, has already been output from the standby buffer 42 to the normal output queue 43a, has already been input in the normal output queue 43a, and has already been output from the normal output queue 43a. In this case, the first print (or printing of one copy) of the print job has completed and the print job is waiting for the “job restart instruction”, and the display category of the print job is the fourth category “waiting”.

The symbols V to Z indicate the reservation print jobs “with simultaneous output”, and the “job restart instructions” to the print jobs have been input via the operation receiving section 31. The symbol V indicates a status in which the print job has already been input in the standby buffer 42, is being output from the standby buffer 42 to the normal output queue 43a (the normal output queue 43a is inputting the print job), and has not yet been output from the normal output queue 43a. In this case, the print job is in the preparation process, and the display category of the print job is the third category “in preparation”.

The symbol W indicates a status in which the print job has already been input in the standby buffer 42, has already been output from the standby buffer 42 to the normal output queue 43a, has already been input to the normal output queue 43a, and has not yet been output from the normal output queue 43a. In this case, the print job is waiting for the completion of output of the other print jobs that have been placed above the print job in the print queue 43 (the interrupt output queue 43b or the normal output queue 43a), and the display category of the print job is the third category “in preparation”. The symbol X indicates a status in which the print job has already been input in the standby buffer 42, is being output from the standby buffer 42 to the normal output queue 43a (the normal output queue 43a is inputting the print job), and is being output from the normal output queue 43a. In this case, the display category of the print job is the second category “outputting”. The symbol Y indicates a status in which the print job has already been input in the standby buffer 42, has already been output from the standby buffer 42 to the normal output queue 43a, has already been input to the normal output queue 43a, and is being output from the normal output queue 43a. In this case, the display category of the print job is the second category “outputting”.

The symbol Z indicates a status in which the print job has already been input in the standby buffer 42, has already been output from the standby buffer 42 to the normal output queue 43a, has already been input to the normal output queue 43a, and has already been output from the normal output queue 43a. In this case, although printing of the print job has completed, the print job (the reprint job or the sample print job) remains stored in the standby buffer 42, and thus the print job is waiting for the “job restart instruction”, and the display category of the print job is the fourth category “waiting”. If the print job is deleted from the standby buffer 42 in response to the “job stop instruction”, the display relating to the print job is erased from the job list.

### 4. Job List Display Control Process

Based on the above description, a process of controlling the display of a job list to be performed by the display control section 32 will be described. FIG. 3 is a flowchart showing a process of controlling the display of a job list. This flowchart shows a display control process to be performed by the display control section 32 on a target job that is recognized by the printer 10. Here, a job to be a target of the display control process is referred to as a target job for convenience. It should be noted that since the job list displays a plurality of print jobs or other jobs in the list, each of the jobs on the list corresponds to the target job, and the process shown in FIG. 3 is performed in parallel on the respective jobs.

The display control section 32 determines a job status of a target job (step S100). The display control section 32 determines a job as a target job when the display control section 32 recognizes the occurrence of the job. The display control section 32 can recognize the occurrence of a print job, for example, when the display control section 32 recognizes that the operation receiving section 31 has received an instruction for starting (starting copying of a document) reading of a document by the scanner 60. If the reception module 20 detects that a print job has been received in the input system (the receiving section 21, 22, 23, or 24), the reception module 20 notifies the display control section 32 that the reception of the print job has been started. Consequently, also by the notification, the display control section 32 can recognize the occurrence of the print job. The reception module 20 also notifies the completion of the reception of the print job to the display control section 32 when the reception of the print job started in the input system (the receiving section 21, 22, 23, or 24) has completed.

The display control section 32 receives, from the output module 40 (output controller 41) as needed, notifications of statuses of print jobs to be processed by the output controller 41, for example, input/output statuses of the print jobs in the standby buffer 42, and input/output statuses of the print jobs in the print queue 43 described in FIG. 2. Accordingly, based on the operation contents received by the operation receiving section 31, the notifications from the reception module 20, or the notifications from the output module 40, the display control section 32 can recognize target jobs and determine the current statuses of the target jobs (step S100).

When the display control section 32 recognizes the occurrence of a print job (the reception of a print job by the reception module 20) and determines that the print job is a target job, the display control section 32 determine that the status of the target job is the status “waiting” in most cases. In step S100, if the display control section 32 determines that the status of the target job is the status “waiting”, the processing proceeds to step S130, and determines that the display category of the target job is the fourth category “waiting”. In step S140, the display control section 32 adds the display relating to the target job to the bottom of the current job list in the display order on the display with the display section 33. The display relating to the target job indicates information including predetermined items appropriate for users expected to see the job list to understand the outline of the job. After step S140, the display control section 32 returns to the determination in step S100.

In step S100, the display control section 32 determines again the status of the target job, and if the status of the target job has been changed (if the display category is to be changed), proceeds to a next step in the flowchart in FIG. 3. For example, if the display control section 32 determines that the preparation process has been started for the target job that has been categorized into the fourth category “waiting”, the display control section 32 proceeds from step S100 to step S150. In step S150, the display control section 32 determines the display category of the target job to be the third category “in preparation”, and the display control section 32 proceeds to step S160.

In step S160, the display control section 32 determines whether the current job list being displayed by the display section 33 includes one or more print jobs of the fourth category with higher priority in the display order than the target job. If the job list includes a print job of the fourth category with higher priority in the display order than the target job (“Yes in step S160), the display control section 32 proceeds to step S170.

In step S170, the display control section 32 moves the display relating to the target job one above the print job of the fourth category with the highest priority in the display order among the print jobs with higher priority in the display order than the target job. After step S170, the display control section 32 returns to the determination in step S100. If there is no print job of the fourth category with higher priority in the display order than the target job (“No in step S160), the display control section 32 returns to step S100 without performing the process in step S170, that is, without changing the position of the display relating to the target job in the job list.

If the display control section 32 determines, for example, that the output to the printer engine 50 has been started for the target job that has been categorized into the third category “in preparation”, the display control section 32 proceeds from step S100 to step S180. As will be understood from the above description, for example, the display control section 32 may determine that the status of the target job that has been categorized into the third category “in preparation” has changed while the target job is in the status “waiting” and proceed from step S100 to step S130.

If the display control section 32 determines that a reservation print job stored in the standby buffer 42 to be a target job, while no “job restart instruction” has been issued from the user, the target job remains in the status “waiting”, and accordingly, from the flowchart in FIG. 3, it may seem that the position of the target job in the display order in the job list has not changed. However, the processing in the flowchart in FIG. 3 is performed on each job and even if there is no cause for the target job to change the display position, due to the occurrence of a new job (the reception of a new print job by the reception module 20) or a change in the display position of another job, the position of the target job in the display order may be changed.

In step S180, the display control section 32 determines the display category of the target job to be the second category “outputting”, and the display control section 32 proceeds to step S190. In step S190, the display control section 32 determines whether the current job list being displayed by the display section 33 includes one or more print jobs of the first category or the second category other than the target job. If the job list includes a print job of the first category or the second category (“Yes in step S190), the display control section 32 proceeds to step S200.

In step S200, the display control section 32 moves the display relating to the target job one below the print job of the first category or the second category with the lowest priority in the display order among the print jobs of the first category or the second category that have been determined to be included in the list in step S190. After step S200, the display control section 32 returns to the determination in step S100. If the job list includes no print job of the first category or the second category other than the target job (“No in step S190), the display control section 32 proceeds to step S210.

In step S210, the display control section 32 moves the display relating to the target job to the top of the job list in the display order. After step S210, the display control section 32 returns to the determination in step S100. It should be note that in step S190, when the display control section 32 determines “No”, if the display relating to the target job has already been placed at the top of the job list, step S210 is substantially omitted.

If the display control section 32 determines that the target job is the interrupt job, the display control section 32 proceeds from step S100 to step S220. In step S220, the display control section 32 determines the display category of the target job to be the first category “interrupting”, and proceeds to step S230. In step S230, the display control section 32 determines whether the current job list being displayed by the display section 33 includes one or more print jobs of the first category other than the target job. If the job list includes a print job of the first category (“Yes in step S230), the display control section 32 proceeds to step S240.

In step S240, the display control section 32 moves the display relating to the target job one below the print job of the first category with the lowest priority in the display order among the print jobs of the first category that have been determined to be included in the list in step S230. After step S240, the display control section 32 returns to the determination in step S100. If the job list includes no print job of the first category other than the target job (“No in step S230), the display control section 32 proceeds to step S250.

In step S250, the display control section 32 moves the display relating to the target job to the top of the job list in the display order. After step S250, the display control section 32 returns to the determination in step S100. It should be note that in step S230, when the display control section 32 determines “No”, if the display relating to the target job has already been placed at the top of the job list, step S250 is substantially omitted.

Although not shown in FIG. 3, as described with reference to FIG. 2, the target job (print job) may be deleted from the job list in response to the completion of printing of the target job. The job deleted from the job list is removed from the targets of the display control process (FIG. 3). As will be understood from the above description, for example, the display control section 32 may determine that the status of the target job (reservation print job) that has been categorized into the second category “outputting” has changed while the target job is in the status “waiting” and may proceed from step S100 to step S130. The interrupt job may also be deleted from the job list in response to the completion of printing. If the target job is the interrupt job and the reservation print job, after the completion of printing, the display control section 32 may determine that the status of the target job that has been categorized into the first category “interrupting” has changed while the target job is in the status “waiting” and may proceed from step S100 to step S130.

The processes in steps S110 and S120 in FIG. 3 will be described. If the printer 10 is a multifunction peripheral, the printer 10 can process jobs other than print jobs. For example, the printer 10 performs facsimile transmission using the facsimile data receiving section 24 (facsimile communication section). The printer 10 may include a network interface for communication via a network such as a local area network (LAN), and the Internet, and can send image data or other data to the outside using a predetermined protocol via the network interface. As described above, to process jobs other than print jobs, the printer 10 may add jobs (for example, a facsimile transmission job to be processed in facsimile transmission, a network transmission job to be transmitted to the outside via the network, and the like) to the job list.

The processes in steps S110 and S120 are performed when a target job is a job other than print jobs. If the display control section 32 determines that the recognized target job is a job other than print jobs, the display control section 32 proceeds from step S100 to step S110. In step S110, the display control section 32 determines the display category of the target job to be the fifth category “other”. The fifth category is a display category for jobs other than print jobs. In step S120, the display control section 32 adds the display relating to the target job to the bottom of the current job list being displayed by the display section 33 in the display order. After step S110, the display control section 32 returns to the determination in step S100.

The display categories of jobs other than print jobs are not changed to the above-described first to fourth display categories. According to the flowchart in FIG. 3, the job of the fifth category is not displayed at a position higher than the jobs of the first category or the second category in the job list. The job in the fifth category, however, may be displayed at a position higher than jobs in the third category or the fourth category in the job list. In other words, print jobs of the fourth category or the third category that have submitted after the job of the fifth category are displayed at positions lower than the job in the fifth category in the job list.

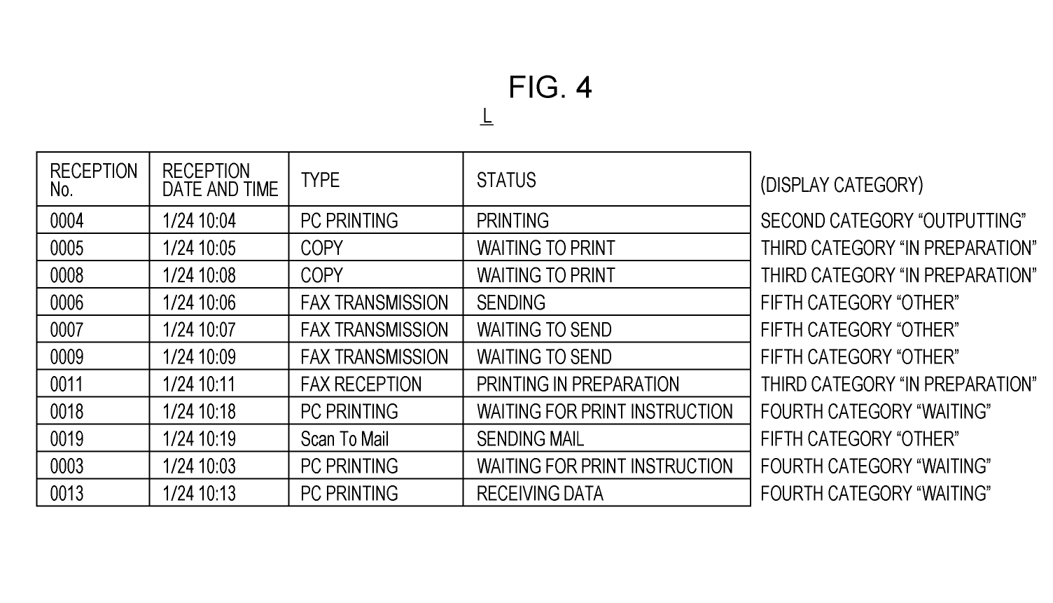

FIG. 4 illustrates an example job list L to be displayed on the display section 33 by the display control section 32. The job list L shows jobs each provided with items such as “reception No.”, “reception date and time”, “type”, and “status” for users to readily understand the job. The item “reception date and time” in the job list L indicates the date and time the printer 10 recognizes the occurrence of a job (an instruction from a user for executing (printing) a job) or the reception of a job from an external device. In other words, the “reception date and time” is the date and time the reception section receives a job. The “reception No.” in the job list L indicates numbers sequentially assigned to jobs from a job that has earlier “reception date and time”.

The “type” in the job list L indicates the types of jobs in plain wording, for example, the “PC printing” refers to a print job that has been received from a PC 80, the “copy” refers to a print job that has been received from the scanner 60, and the “fax reception” refers to a print job that has been received from the facsimile machine 90. The “fax transmission” refers to a job (a job other than print jobs) that is faxed to the outside by the facsimile data receiving section 24 (facsimile communication section), and the “ScanToMail” refers to a job (a job other than print jobs) for sending an image read by the scanner 60 to the outside by an e-mail via the above-described network interface.

The “status” in the job list L indicates the current statuses of jobs in plain wording, and the display categories of the jobs are reflected to some extent. In FIG. 4, the display category of each job is also described in the margin of the job list L. In the job list L in FIG. 4, a print job (reception No. 0004) in the second category “outputting” is placed at the top, and jobs in the third category “in preparation”, jobs in the fourth category “waiting”, and jobs in the fifth category “other” are placed at positions lower than the print job in the second category. The print jobs (the reception Nos. 0005, 0008, and 0011) in the third category “in preparation” are displayed at positions higher than the print jobs (the reception Nos. 0018, 0003, and 0013) in the fourth category “waiting”. In FIG. 4, although the reception date and time of the print job “PC printing” of reception No. 0003 is earliest in the job list L, the print job is in the fourth category “waiting” and displayed at a considerably lower position. This is because the print job is a reservation print job that has been stored in the standby buffer 42 and waiting for a “job restart instruction” for a long time.

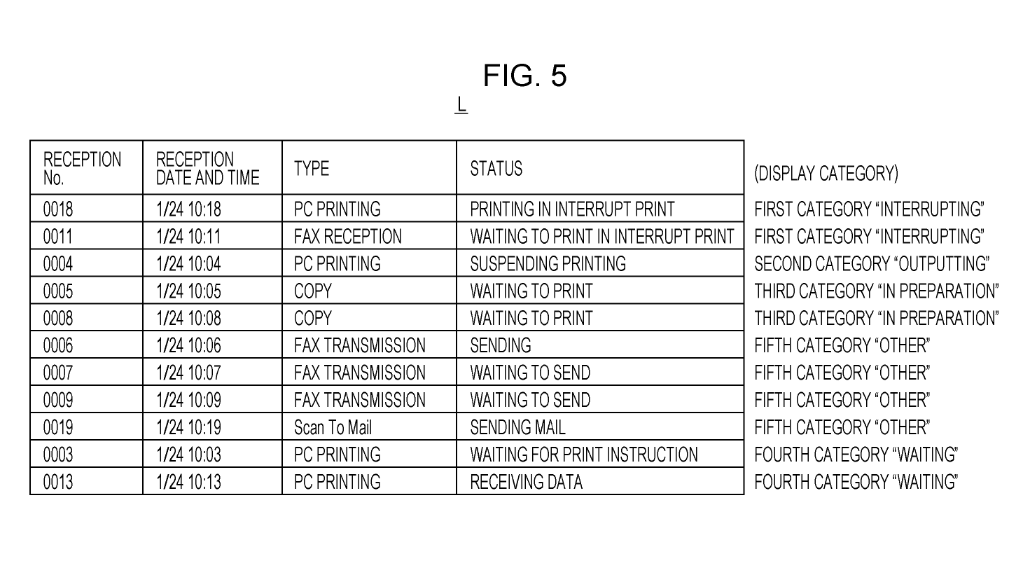

FIG. 5 illustrates an example job list L to be displayed on the display section 33 by the display control section 32, and the example job list L is different from that in FIG. 4. The items in FIG. 5 are similar to those in FIG. 4. Comparing FIG. 5 with FIG. 4, statuses of the two print jobs of reception No. 0018 and reception No. 0011 in FIG. 4 are changed to the first category “interrupting” in FIG. 5. This means that when the statuses in the job list L were statuses shown in FIG. 4, the user requested interruption with respect to the print job (the fourth category “waiting”) of reception No. 0018, and further requested interruption with respect to the print job (the third category “in preparation”) of reception No. 0011. As a result, the categories of the two print jobs of reception No. 0018 and reception No. 0011 have been changed to the first category “interrupting”, and the print jobs have been moved to positions higher than the jobs of the second to fifth categories.

In the two print jobs of reception No. 0018 and reception No. 0011, the interruption instruction was issued first to the print job of reception No. 0018. Accordingly, in the job list L in FIG. 5, the print job of reception No. 0018 is displayed at a higher position and the “statuses” of the print jobs are displayed as “printing in interrupt print” for the print job of No. 0018 and “waiting to print in interrupt print” for the print job of No. 0011 (see FIG. 5). Printing of the print job (the second category “outputting”) of reception No. 0004 that was placed at the top in the job list L until the occurrence of the interruption is suspended due to the interruptions and the “status” of the print job is displayed as “suspending printing” (see FIG. 5).

### 5. Summary

According to the embodiment, the printer 10 includes the receiving section (the reception module 20 and the operation receiving section 31) that receives print jobs, and the display control section 32 that causes the display section 33 to display a list (job list) of the print jobs received by the receiving section. The printer 10 also includes the print control section (the output controller 41) that outputs a print job to the printer engine 50 and instructs the printer engine 50 to perform printing in accordance with the print job. The output controller 41 can output a reservation print job to the printer engine 50 in response to a print instruction (job restart instruction) issued to the reservation print job that has been stored in the standby buffer 42 after the input of the job. The display control section 32 causes a print job (for example, a print job in the second category “outputting” or the first category “interrupting”) that is to be output to the printer engine 50 to be displayed at a position higher than the position of a print job (a print job in the fourth category “waiting”) that is waiting for a print instruction among reservation print jobs in the job list.

With this configuration, a print job that is to be output to the printer engine 50 is displayed at a position higher than the positions of reservation print jobs that are waiting for print instructions in a job list. In other words, the display control section 32 displays a print job to be output to the printer engine 50 at a position higher than the positions of reservation print jobs that are waiting for print instructions in the display order in the job list (changes the display order of the print jobs in the job list) if the date and time the receiving section has received the reservation print jobs that are print jobs waiting for print instructions (job restart instructions) are earlier than the date and time the receiving section has received the print job to be output to the printer engine 50 in response to a print instruction (a print instruction received via the operation receiving section 31 at the time of receiving the print job, or a job restart instruction). For example, as shown in the job list L in FIG. 4, the print job “PC printing” (the second category “outputting”) of reception No. 0004 having the later reception date and time is displayed at the higher position than the position of the print job “PC printing” (the fourth category “waiting”) of reception No. 0003. Consequently, the print jobs are displayed in a manner highly consistent with actual print job processing order. As a result, the problem that users are prevented from recognizing print jobs to be actually printed earlier than reservation print jobs in the list due to reservation print jobs that have been input earlier in the printer and in the waiting state and being placed at higher positions in the list can be solved. In the above-described embodiment, the configuration that includes the reception module 20 and the operation receiving section 31 is referred to as the receiving section. Alternatively, a configuration that includes the reception module 20 but does not include the operation receiving section 31 may be referred to as the receiving section, or a configuration that does not include the reception module 20 but includes the operation receiving section 31 may be referred to as the receiving section.

In this embodiment, the display control section 32 causes a print job (a print job in the third category “in preparation”) on which the preparation process is to be performed and the output to the printer engine 50 has not yet started to be displayed at a position higher than the position of a print job (a print job in the fourth category “waiting”) that is waiting for a print instruction among reservation print jobs in the job list. Furthermore, the display control section 32 causes a print job that is to be output to the printer engine 50 to be displayed at a position higher than the position of the print job on which the preparation process is to be performed. With this configuration, the print jobs can be displayed in the order of (the first category “interrupting”), the second category “outputting”, the third category “in preparation”, and the fourth category “waiting” in a job list. Accordingly, a list of a plurality of print jobs can be displayed in a manner highly consistent with the actual order in which the print jobs are processed by the printer 10.

In this embodiment, the display control section 32 causes the display section 33 to display a job list that includes print jobs and jobs (for example, facsimile transmission jobs and network transmission jobs) other than print jobs. The display control section 32 causes the display section 33 to display the jobs (jobs in the fifth category “other”) other than the print jobs at positions lower than the position of a print job to be output to the printer engine 50 in the job list. This configuration enables users to readily check print jobs and jobs other than the print jobs to be processed by the printer 10 in one job list and to provide uses with the job list by separately displaying the jobs other than the print jobs from the print jobs (print jobs to be printed with higher priority) to be output to the printer engine 50.

### 6. Other Embodiments

The present invention is not limited to the above-described embodiment and various embodiments may be provided. For example, the display control section 32 may separately list print jobs and jobs other than the print jobs and display the lists on the display section 33 (according to a switching operation by a user). This specification in which print jobs and jobs other than the print jobs are displayed in separate job lists is referred to as a first display specification. The specification in which a job list that includes print jobs and jobs other than the print jobs is displayed on the display section 33 as described above with reference to FIGS. 3, 4, and 5 is referred to as a second display specification.

The operation receiving section 31 also serves as a display specification receiving section that receives a selection of the first display specification or the second display specification from a user. When the operation receiving section 31 receives a selection of the first display specification, the display control section 32 employs the first display specification. On the other hand, when the operation receiving section 31 receives a selection of the second display specification, the display control section 32 employs the second display specification. This embodiment enables users to select one of the first display specification and the second display specification and thereby satisfies preferences of various users.

In the job lists L in FIGS. 4 and 5, the display categories of individual jobs are not displayed, that is, the first category “interrupting”, the second category “outputting”, the third category “in preparation”, the fourth category “waiting”, and the fifth category “other” are not displayed. Alternatively, the display control section 32 may display such display categories of individual jobs within the job lists L.

In the above-described embodiment, the CPU (processor) performs each process. In this specification, however, the CPU may include a single or a plurality of CPUs or may include one or more integrated circuits such as application-specific integrated circuits (ASICs). The CPU may be a combination of one or more CPUs and one or more integrated circuits.

The entire disclosure of Japanese Patent Application No. 2017-097042, filed May 16, 2017, is expressly incorporated by reference herein.

What is claimed is:

1. A printing apparatus comprising:
a receiving section configured to receive print jobs; and
a display control section configured to cause a display section to display a list of the print jobs received by the receiving section,
wherein if date and time the receiving section received a reservation print job that is a print job waiting for a print instruction is earlier than date and time the receiving section receives a print job to which a print instruction has been issued and to be output to a print section, the display control section causes the display section to display the print job to be output at a position in the list higher than the position of the reservation print job waiting for a print instruction.

2. The printing apparatus according to claim 1, wherein the display control section causes the display section to display a print job on which a preparation process is to be performed and the output to the print section has not yet been started at a position in the list higher than the position of the print job waiting for a print instruction among the reservation print jobs.

3. The printing apparatus according to claim 2, wherein the preparation process includes at least one of a storing process for storing a print job in a predetermined buffer and a storing process for storing a print job in a print queue.

4. The printing apparatus according to claim 2, wherein the display control section causes the display section to display the print job to be output at a position in the list higher than the position of the print job on which the preparation process is to be performed.

5. The printing apparatus according to claim 1, wherein the display control section causes the display section to display the list including a print job, a facsimile transmission job to be processed in facsimile transmission, and a network transmission job to be transmitted to the outside via a network.

6. The printing apparatus according to claim 5, wherein the display control section causes the display section to display the facsimile transmission job and the network transmission job at positions in the list lower than the position of the print job to be output.

7. The printing apparatus according to claim 5, further comprising a display specification receiving section configured to receive a selection of a first display specification for displaying the print job in a list and displaying the facsimile transmission job and the network transmission job in another list, or a second display specification for displaying the list including the print job, the facsimile transmission job, and the network transmission job,
wherein the display control section causes the display section to display the list including the print job, the facsimile transmission job, and the network transmission job when the second display specification is selected.

8. A print job displaying method comprising:
receiving print jobs; and
causing a display section to display a list of the received print jobs,
wherein if date and time of the reception of a reservation print job that is a print job waiting for a print instruction received in the receiving is earlier than date and time of the reception of a print job to which a print instruction has been issued and to be output to a print section received in the receiving, in the causing the display section to display the list of the received print jobs, displaying the print job to be output at a position in the list higher than the position of the reservation print job waiting for a print instruction.
